(19) United States
(12) Patent Application Publication
(10) Pub. No.: US 2002/0083009 A1
(43) Pub. Date: Jun. 27, 2002

(54) System and method for completing on-line transactions and micro-transactions

(76) Inventors: Paul Lansing, Orangeville (CA); Kevin R. Alexander, Cambridge (CA); Philip Neukom, Oakville (CA)

Correspondence Address: Bhupinder S. Randhawa, Bereskin & Parr, Box 401, 40 King Street West, Toronto, ON, M5H 3Y2, CA

(21) Appl. No.: 09/957,069

(22) Filed: Sep. 21, 2001

Related U.S. Application Data
(60) Provisional application No. 60/234,325, filed on Sep. 22, 2000.
(60) Provisional application No. 60/234,226, filed on Sep. 21, 2000.

(51) Int. Cl. G06F 17/60

(52) U.S. Cl. 705/64

(57) ABSTRACT

A system and method for completing a transaction over a computer without transmitting personal information is disclosed. A purchaser uses a purchaser appliance establishes a communication session with a vendor server, which is operated by a vendor. The session is monitored by a transaction management server, which is operated by a transaction manager. When the purchaser indicates that he wishes to make a transaction, the transaction management server reviews and determines whether the transaction should be authorized, possibly based on the purchaser's credit history. If the transaction is authorized, the transaction is completed through the transaction manager. At no time does the vendor server or the vendor learn the identity of the purchaser.

### FIELD OF THE INVENTION

This invention relates to transactions made over a network, including transactions conducted using a computer network such as the Internet or a telecommunications network such as a telephone network.

### BACKGROUND OF THE INVENTION

The Internet and the World Wide Web (the audio-visual portion of the Internet) are gaining increasing importance as a marketplace for goods and services.

Although the value and size of this market are immense, use of the Internet for any purpose, and particularly for commercial transactions, is subject to security and privacy problems.

When an Internet based transaction is made, it is generally necessary for the purchaser to provide personal information such as the purchaser's identity and address (either a physical shipping address or an e-mail address or both) to the vendor. This information is used to deliver the product or service purchased and may be used to track the purchasing history of individual purchasers in order to identify purchasing patterns, etc. Furthermore, this information may be used subsequently to send unsolicited advertising and other information to the purchaser. In many cases, purchasers prefer to make anonymous transactions in which the vendor is unable to ascertain the identity of the purchaser. Known systems for facilitating transactions over the Internet do not provide for such privacy, with the result that some people refuse to enter into on-line transactions.

Another problem relates to the possibility that payment information, such as credit card numbers, etc. may be recorded and misused by dishonest persons. The Internet is a “store-and-transmit” system, in which information may be stored in a number of locations (servers or routers) while being transmitted to its final destination. It is possible that these multiple copies of information may be viewed and misused. Furthermore, messages transmitted on the Internet can be monitored based on their contents, and the contents of selected messages may be misused.

As a result, many people refuse to transmit such payment information over the Internet.

Yet another problem with known methods of making on-line payments is their relatively high overhead cost per transaction. There is an increasing need for a reliable and secure method of making relatively small payments. For example, a company which provides on-line stock market information may wish to charge a small amount such as 10 cents for individual stock quotes. Such a small value transaction may be referred to as a “micro-transaction”. (Other micro-transactions may have larger values up to several dollars.) Typically, credit card and other transactions have an overhead of several dollars, which results from the complex transaction authorization and reconciliation systems used for such transactions. As a result, it is not cost effective for a credit card issuer to permit the use of its credit cards for micro-transactions.

Accordingly, a transaction authorization system is required which will allow a purchaser to make an on-line payment without transmitting personal information or sensitive payment information over the Internet. Furthermore, there is a need for a transaction authorization system which may be used to cost effectively facilitate micro-transactions. Preferably, such a system will provide an efficient and low cost mechanism for approving and reconciling transaction.

### SUMMARY OF THE INVENTION

The present invention provides a transaction completion system in which a purchaser may establish a communication session between a purchaser appliance and a vendor server over a communication network. The vendor server is operated by a vendor. The communication sessions is established through a communication gateway, which is controlled by a transaction management. The transaction management server includes a session monitor which monitors data transmitted in the communication session and tracks details related to a transaction. When the purchaser has finalized the terms of the transaction, the vendor server requests that the transaction management server authorize it. The transaction management server refers to the transaction to an associated credit management server, which evaluates the transaction and either authorizes or denies it. If the transaction is authorized, then the vendor server completes the transaction by transmitting the product or service purchased to the purchaser, either electronically or through the transaction management server. The transaction manager obtains payment from the purchaser, which is shared between the transaction manager and the vendor.

The vendor does not learn the identity of the purchaser at any time, since (i) all transaction authorizations are conducted by the transaction management server or an associated credit management server, (ii)since physical shipments are relayed through the transaction manager and (iii) payments are relayed through the transaction manager.

The system may operate with a relatively low overhead cost since transactions are automatically approved and monies are periodically relayed to the vendor in payment of authorized transactions. This can permit the elimination or reduction of costly reconciliation procedures.

Optionally, the vendor may acquire identity and physical address information about the purchaser. This may allow the vendor to ship products directly to the purchaser rather than relaying them through the transaction manager. In addition, this may allow the vendor to present personalized information about the purchaser on the vendor server.

In one aspect, the present invention provides a method for authorizing an on-line transaction comprising the steps of: registering a purchaser in a purchaser registry; registering a vendor in a vendor registry; initiating a session monitor to monitor data transmitted on a communication session established between a purchaser appliance operated by said purchase and a vendor server operated by said vendor; recording data related to said transaction; approving said transaction based on said recorded data, said purchaser registry and said vendor registry.

In another aspect, the present invention provides a transaction completion system for authorizing an on-line transaction comprising: a communication network; a purchaser appliance; a vendor server; a communication gateway coupled to said communication network for controllably allowing a communication session to be created between said purchaser appliance and said vendor server; a transaction management server for controlling said communication gateway and for initiating a session monitor for tracking data transmitted in said communication session relating to said on-line transaction; and a credit management server coupled to said transaction management server for authorizing said on-line transaction.

### BRIEF DESCRIPTION OF THE DRAWINGS

A preferred embodiment of the present invention will now be described in detail with reference to the drawings, in which:

FIG. 1 is a block diagram illustrating a transaction completion system according to the present invention;

FIG. 2 is a flowchart illustrating a method of registering a purchaser of the system of FIG. 1;

FIG. 3 is a flowchart illustrating a method of configuring a vendor web site of the system of FIG. 1; and

FIG. 4 is a flowchart illustrating a method of completing a transaction using the system of FIG. 1.

### DETAILED DESCRIPTION OF THE PREFERRED EMBODIMENT

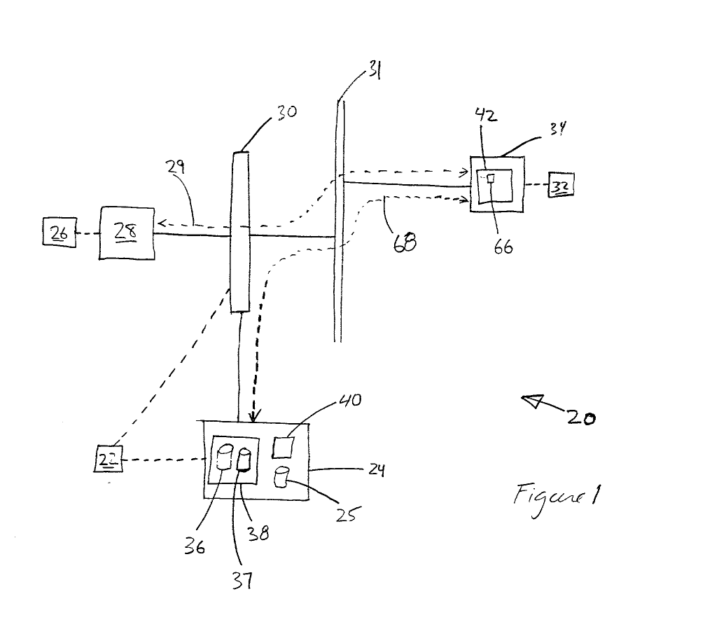

Reference is first made to FIG. 1, which illustrates a transaction completion system 20. System 20 includes a transaction manager 22, a transaction management server 24, a purchaser 26, a purchaser appliance 28, a communications gateway 30, a communication network 31, a vendor 32, a vendor server 34 and a credit manager server38.

Purchaser 26 may operate purchaser appliance 28 to establish a communication session 29 between purchaser appliance 28 and vendor server 34.

The communication session 29 is established utilizing communication gateway 30 and communication network 31. Transaction manager 22 operates transaction management server 24, which is coupled to gateway 30 to control its use by purchaser 26.

As an example, transaction manager 22 may be an Internet service provider (ISP), communication network 31 may be the Internet and communication gateway 30 may be a computer system which allows purchaser appliance 28 to be coupled to communication network 31. In this case, purchaserappliance 28 will be a computer configured with an Internet browser. Purchaser 26 will see communication session 29 as a browser window on this computer.

Alternatively, communication network 31 may be another network such as a telephone or television cable system and transaction manager 22 may be a provider of telephone or cable service. In this case, purchaser appliance 28 may be telephone or a television screen.

Transaction management server 24 includes a user registry 25 which contains an account code and password for each purchaser 26 that is authorized to use communication gateway 30 to access communication network 31. Transaction management server 24 includes a credit management server 38. In an alternative embodiment of a transaction completion system according to the present invention, credit management server 38 may be external to transaction server 24 and may be operated by a credit manager (not shown) who provides credit evaluation services to transaction manager 22.

When purchaser 26 initiates communication session 29, a session monitor 40 is initiated within transaction management server 24 to monitor all data transmissions which occur to and from purchaser appliance 28 during communication session 29. The session monitor 40 does so by tracking relevant data flow through communication gateway 30.

Credit management server 38 includes a purchaser registry 36 and a vendor registry 37. Purchaser registry 36 contains identification, billing and product delivery information relating to purchaser 26. This information is provided by purchaser 26 and is used to authorize transactions made by purchaser 26 and to deliver items purchased by purchaser 26 to him or her. Vendor registry 37 contains identification and payment information relating to vendor 32. This information is used to make payments to vendor 32.

Vendor server 34 is operated by vendor 32 to advertise and sell goods and services to purchaser 26 in exchange for a payment. If communication network 31 is the Internet, vendor server 34 may include a vendor web site 42. Purchaser 26 may access vendor web site 42 using purchaser appliance 28, (i.e. a computer equipped with an Internet browser).

Before transaction completion system 20 may be used by a purchaser 26 to buy an item from vendor 32, transaction manager 22 must specify a data identification standard which may be used by purchaser appliance 28, vendor server 34 and session monitor 40 to identify data relating to a transaction. This data is used by transaction manager 22 and credit management server 38 to authorize and process a transaction between purchaser 26 and vendor 32.

The operation of transaction completion system will now be described with reference to an exemplary system in which transaction manager 22 is an ISP. Communication gateway 30 is a computer system which provides access to communication network 31, which is the Internet. Purchaser 26 is an individual who obtains access to the Internet using communication gateway 30 (i.e. transaction manager 22 is the purchaser's ISP). Purchaser appliance 28 is a computer equipped with an Internet browser. Vendor 32 is a retailer which operates vendor server 34 and vendor web site 42 to describe various products and services and to offer them for sale.

In this exemplary system, the data identification standard consists of a set of data identification tags which may be embedded data transmitted to and from purchaser appliance 28 during communication session 29. These tags include a VENDOR ID tag 50, a TRANSACTION ID tag 52 and a TRANSACTION AMOUNT TAG 54. Each tag is used to identify corresponding data during communication session 29 to identify the transaction, the parties to the transaction and the amount of the transaction. Data identification tags also include a COMPLETE TRANSACTION tag 55 and a REQUEST AUTHORIZATION tag 56 which are transmitted to indicate that a transaction is ready for completion. Tags 46 also include a TRANSACTION AUTHORIZED tag 58 and a TRANSACTION NOT AUTHORIZED tag 59 which are used to indicate whether a transaction has been authorized by transaction management server 24.

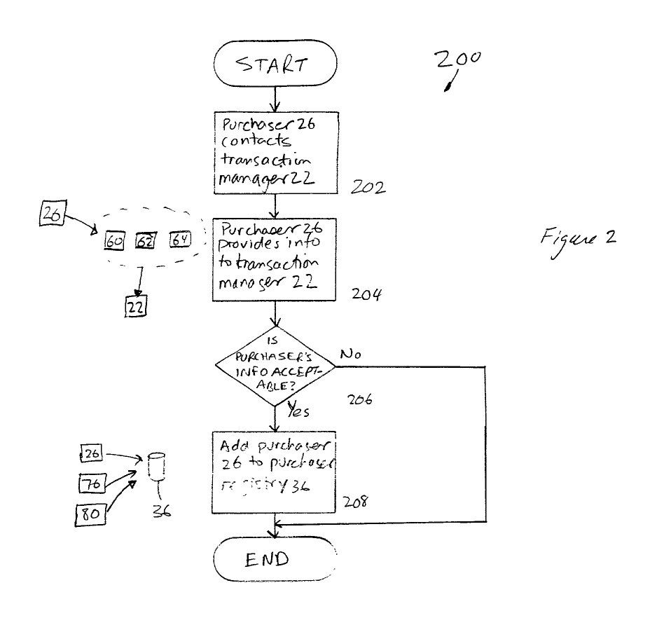

Prior to using system 20 to make a transaction, purchaser 26 must be registered in purchaser registry 36. Reference is made to FIG. 2, which illustrates a method 200 by which purchaser 26 may do so.

Method 200 begins in step 202, in which purchaser 26 contacts transaction manager 22 (who operates credit management server 38 as part of transaction management server 24). In system 20, purchaser 26 may do so by establishing a connection between his purchaser appliance 28 and transaction management server 24 via communication gateway 30. Alternatively, purchaser 26 may do so by telephoning a representative of transaction manager 22.

In step 204, purchaser 26 provides personal information 60, delivery information 62 and payment information 64 to transaction manager 22 (or to transaction management server 24). Personal information 60 which may include the purchaser's name and/or other information which identifies purchaser 26. Delivery information 62 may include a street address, post office box, e-mail address or other address to which goods and services purchased by purchaser 26 may be delivered.

Payment information 64 may include account information relating to a service for which purchaser 26 receives a regular invoice (i.e. the account number of the purchaser's account with a service provider such as a telephone company, cable company or gas company, etc.). This account information must relate either to a service already provided to purchaser 26 by transaction manager 22 or by another entity with which transaction manager 22 has entered into a payment collection agreement.

In the present example, transaction manager 22 is an ISP. Since purchaser 26 already receives Internet service from transaction manager 22, then payment information 44 may be the account code (or user name) 80 under which that Internet service is delivered.

In the present example, transaction manager 22 has entered into a payment collection agreement with a natural gas delivery company which transmits bills to many persons. A client of this natural gas delivery company may provide his account number with the natural gas delivery company as payment information 44.

Alternatively, payment information 44 may include credit card information such as a credit card number and expiry date, or may simply consist of a billing address (which may or may not be the same as the delivery information) to which transaction manager 22 may send subsequently send an invoice.

Method 200 next proceeds to decision step 206. If the personal information 60, delivery information 62 and payment information 64 is acceptable to transaction manager 22, method 200 proceeds to step 208. Otherwise, method 200 ends.

In step 208, a record is created in purchaser registry 36 for purchaser 26 and personal information 60, delivery information 62 and payment information 64 provided by purchaser 26 in step 204 are stored in this record. Transaction management server 24 also assigns a unique purchaser identification code 76 to purchaser 26. Purchaser identification code 76 is cross-referenced with the account code (stored in user registry 25) under which purchaser 26 receives his Internet service. Purchaser identification code 76 and the purchaser's account code 80 are also stored in the record for purchaser 26 in purchaser registry 36.

Method 200 then ends.

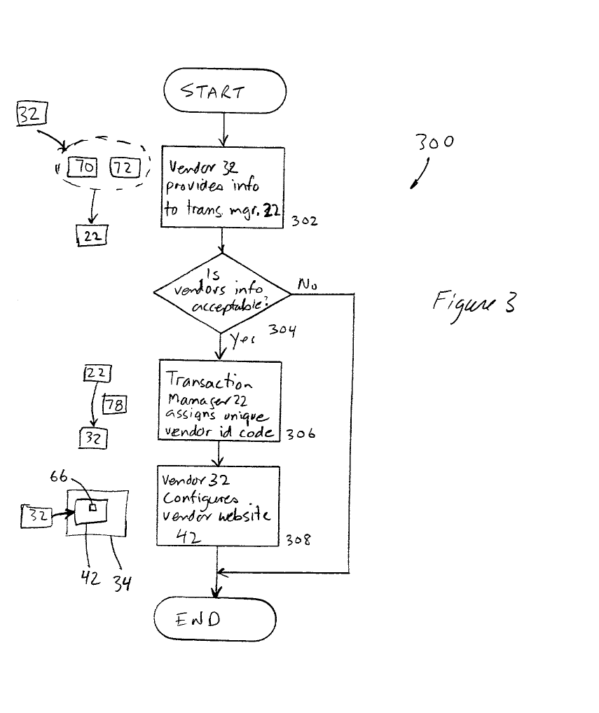

Reference is next made to FIG. 3 which illustrates a method by which vendor 32 may be registered with transaction management server 25 and may configure vendor server 34 for use with transaction completion system 20.

Method 300 begins in step 302. In this step, vendor 32 provides vendor identification information 70 and vendor funds transfer information 72 to transaction manager 22. Vendor identification information 70 may include the business (or personal) name of the vendor and the address (physical and/or electronic) of the vendor. Vendor funds transfer information 72 is used by transaction manager 22 to transfer funds to vendor 32. Vendor funds transfer information 72 may relate to a bank account, credit card account, etc. Alternatively, vendor funds transfer information 72 may direct transaction manager 22 to remit a check to vendor 32.

Method 300 next proceeds to decision step 304. If the vendor identification information 70 and vendor funds transfer information 72 provided by vendor 32 in step 302 is acceptable to transaction manager 22, then method 300 proceeds to step 306. Otherwise, method 300 ends.

In step 306, transaction manager 22 assigns a unique vendor identification code 78 to vendor 32. Transaction manager 22 records vendor identification information 70, vendor funds transfer information 72 and vendor identification code 78 in vendor registry 37. Transaction manager 22 also transmits this vendor identification code 78 to vendor 32.

Method 300 next proceeds to step 308. In this step, vendor 32 configures vendor web site 42. Vendor web site 42 has at least one transaction page 66 on which a product or service is offered for sale at a fixed or negotiable price. Vendor 32 configures vendor web site 42 to operate as follows:

i. Vendor web site 42 is configured to display information about the vendor's products and/or service.

ii. Vendor web site 42 does not receive any information relating to the identity of purchaser 26.

iii. While a purchaser selects the product or service for a transaction, vendor web site 42 will transmit information relating to the transaction ark using TRANSACTION ID tag 52 and TRANSACTION AMOUNT tag 54 and VENDOR ID tag 50 on communication session 29.

iv. While viewing vendor web site 42, if purchaser 26 indicates that he wishes to complete the transaction, vendor web site 42 will (a) transmit CONFIRM TRANSACTION tag 55 on communication session 29 and (b) will request that the transaction be authorized by establishing a separate communication session 68 with transaction management server 24 and transmitting TRANSACTION ID tag 52 and REQUEST AUTHORIZATION tag 56 on communication session 68.

v. After requesting that a transaction be authorized, vendor web site 42 waits for a TRANSACTION AUTHORIZED tag 58 or TRANSACTION NOT AUTHORIZED tag 59 from transaction manager 22 and will complete the transaction only if it is approved by transaction manager 22 and if the details of the transaction approved by transaction manager 22 correspond to those transmitted by vendor web site 42.

Vendor web site 42 may be configured to provide any number of products and services. In addition, vendor web site 42 may be configured to deliver products and services to purchaser 26 electronically via communication network 31 or by physical shipment.

In the present exemplary embodiment, vendor web site 42 does not acquire information relating to the identity or physical address of purchaser 26. This information is not required for electronic delivery products and services, which may simply be transmitted to the electronic address from which purchaser 26 has requested the product or service. In this present case, this is the IP address at which purchaser appliance 28 is connected to the communication network 31 (the Internet).

If physical shipment of a product or service is required, this is done via the transaction manager, as described below.

Method 300 then ends.

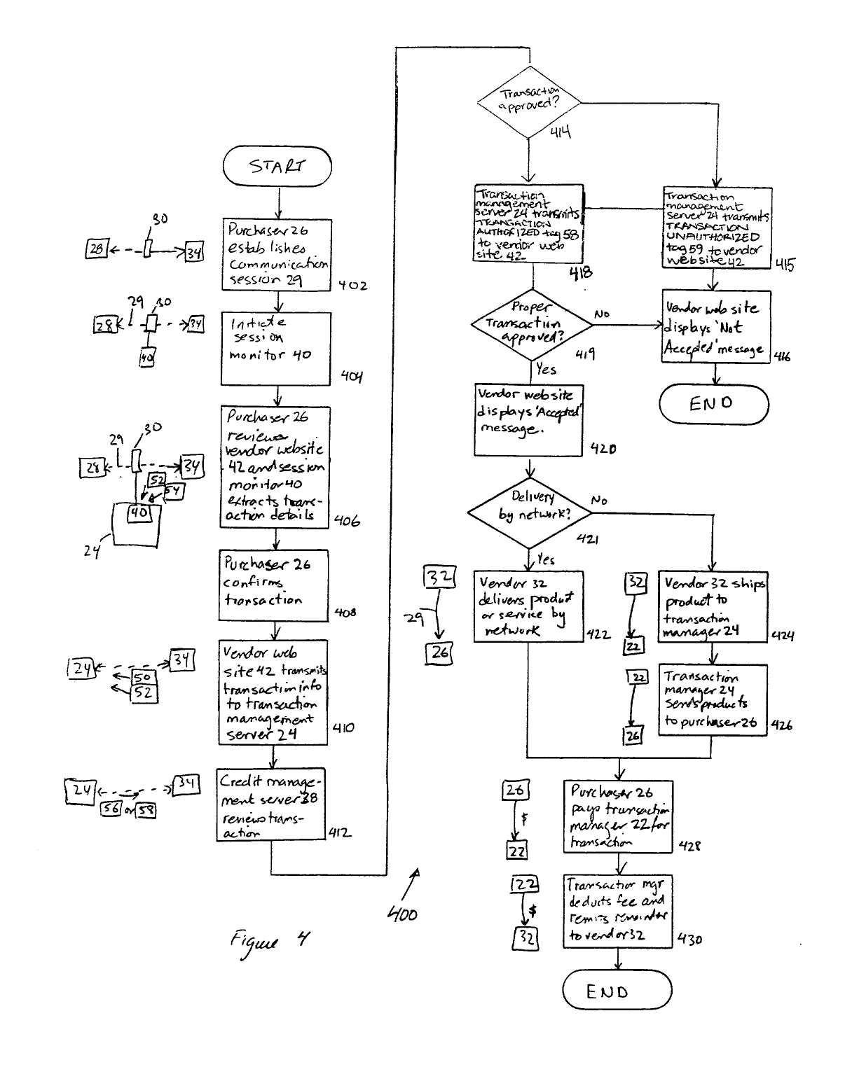

Reference is next made to FIG. 4 which illustrates a method 400 by which a transaction may be carried out according to the present invention.

Method 400 begins in step 402 in which purchaser 26 establishes communication session 29. Purchaser 26 first establishes a connection between purchaser appliance 28 and transaction management server 24 through communication gateway 30. Purchaser 26 then enters his account code (i.e. user name) and password in a browser window to identify himself and to authorize the use of his account to pay for the connection between purchaser appliance 28 and communication network 31. If the account code and password entered are valid, transaction manager 22 permits the establishment of communication session 29.

Method 400 next proceeds to step 404 in which transaction management server 24 initiates session monitor 40. Session monitor 40 tracks all data communication to and from purchaser appliance 28 during communication session 29 and maintains a record of information which is transmitted utilizing the data identification tags .

If purchaser 26 creates a second communication session (i.e. by opening a new browser window), that communication session is considered separate from communication session 29 and a separate session monitor is created for it.

In step 404, transaction manager 22 also obtains, from purchaser registry 36, the purchaser identification code corresponding to the account code used by purchaser 26 and sends it to session monitor 40.

Method 400 next proceeds to step 406 in which purchaser 26 visits vendor web site 42 during communication session 29 and views transaction page 66. Purchaser 26 selects a product (or a service) which he or she wishes to purchase in a potential transaction. While purchaser 26 is selecting this product, vendor web site 42 transmits information relating to the potential transaction including a transaction identification code (selected by vendor web site 42) and the amount of the transaction. Vendor web site 42 does so by tagging this information using TRANSACTION ID tag 52 and TRANSACTION AMOUNT tag 54.

Session monitor 40 extracts the tagged information from the data communication stream in communication session 29 and records it. During communication session 29, this information may change (i.e. if purchaser 26 selects a different product) and different values may be transmitted using TRANSACTION ID tag 52 and TRANSACTION AMOUNT tag 54. Session monitor 40 keeps track of the most recent information transmitted using these tags 46.

In this exemplary embodiment, vendor web site 42 does not obtain any identity or physical address information relating to purchaser 26 during this or any other step.

Method 400 next proceeds to step 408. In this step, purchaser 26 indicates that he wishes to complete the transaction selected in step 406. Typically, purchaser 26 will do this by selecting a “Confirm transaction” button on transaction page 66. In response to this, vendor web site 42 transmits REQUEST AUTHORIZATION tag 56 on communication session 29. In response to REQUEST AUTHORIZATION tag 58, session monitor 40 transmits the following information to transaction management server 24, which it is previously recorded:

i. the purchaser identification code assigned to purchaser 26;

ii. the transaction identification code; and

iii. the amount of the transaction.

Method 400 next proceeds to step 410. In this step, vendor web site 42 establishes communication session 68 with transaction management server 24. Communication session 68 is independent of communication session 29. Purchaser appliance 28 does not have access to communication session 68. Vendor web site 42 transmits the following information to transaction management server 24 on communication session 68:

i. the vendor identification code assigned to vendor 32, using VENDOR ID tag 50; and

ii. the transaction identification code, using TRANSACTION ID tag 52.

Optionally, vendor web site 42 may also transmit the amount of the transaction.

Method 400 next proceeds to step 412. In this step, credit management server 38 authorizes or denies the transaction. Transaction management server 24 assembles the following information about the transaction and transmits it to credit management server 38:

i. the purchaser identification code assigned to purchaser 26;

ii. the transaction identification code;

iii. the amount of the transaction; and

iv. the vendor identification code assigned to vendor 32.

Credit management server 38 reviews this information and determines whether the transaction should be authorized. This determination may be based on well-known credit analysis techniques which evaluate the credit worthiness of purchaser 26 in relation to the amount of the transaction. In addition, credit management server 38 may review the credibility of vendor 32 in relation to the amount of the transaction.

Method 400 next proceeds to decision step 414. If the transaction was authorized by credit management server 38 in step 412, then method 400 proceeds to step 418. Otherwise, method 400 proceeds to step 416.

In step 416, credit management server 38 transmits a “transaction not authorized” message to transaction management server 24. In response, transaction management server 24 transmits TRANSACTION NOT AUTHORIZED tag 59 to vendor web site 42 using communication session 68. In response to this, vendor web site 42 displays a “transaction refused” message to purchaser 26 using communication session 29. Method 400 then ends.

In step 418, credit management server 38 transmits a “transaction authorized” message to transaction management server 24. In response, transaction management server 24 transmits TRANSACTION AUTHORIZED tag 58 to vendor web site 42 using communication session 68. In addition, transaction management server 24 transmits information of the transaction, including the transaction identification code, the transaction amount to vendor web site 42.

Method 400 next proceeds to step 419 in which vendor web site 42 compares the transaction information transmitted by transaction management server 24 in step 418 with the corresponding information recorded by vendor server 34. If the information transmitted by transaction management server 24 is accurate, method 400 proceeds to step 420. Otherwise, the transaction approved in step 412 is not the same transaction that vendor server 34 intends to enter into and method 400 proceeds to step 416.

In step 420, vendor web site displays a “transaction accepted” message to purchaser 26 using communication session 29.

From step 420, method 400 next proceeds to decision step 421. If the product (or service) purchased by purchaser 26 is to be delivered using communication network 31, then method 400 proceeds to step 422. Otherwise, method 400 proceeds to step 424.

In step 422, vendor web site 42 transmits the product or service to purchaser appliance 28 using communication network 31. Method 400 then proceeds to step 428.

In step 424, vendor 32 ships the product or service to transaction manager 22 (or to a shipping company associated with transaction manager 22). The shipment is identified using the transaction identification number.

From step 424, method 400 proceeds to step 426, in which transaction manager 22 (or an associated shipping company) identifies the purchaser 26 using the transaction identification number and forwards the product or service to purchaser 26.

Method 400 next proceeds to step 428. In this step, transaction manager 22 receives payment for the amount of the transaction in accordance with payment information 64 provided by purchaser 26 in step 204. If purchaser 26 provided an account code for a service already received by purchaser 26 (i.e. Internet service from transaction manager 22 or natural gas from a company with which transaction manager 22 has made a payment collection agreement), then the amount of the transaction is added to the next regular invoice for that service. Purchaser 26 pays the invoice after receiving it. If purchaser 26 provided credit card information, then the purchaser's credit card is charged for the amount of the transaction.

Method 400 next proceeds to step 430, in which transaction manager 22 deducts a fee from the payment received from purchaser 26 in step 428 and transmits the remainder of the payment to vendor 32 using vendor funds transfer information 72. This payment to vendor 32 may be combined with other payments to vendor 32 relating to other transactions. Such a combined payment may be made for many transactions on a periodic bases. In this case, transaction manager 22 transmits an itemized list 74 of the transaction identification numbers with which the combined payment is associated and a breakdown of the amount related to each specific transaction. Vendor 32 may subsequently use this information to ensure that all monies owed to it are received.

Method 400 then ends.

Transaction completion system 20 and methods 200, 300 and 400 provide a mechanism for authorizing and completing transactions. System 20 allows purchaser 26 to purchase a product or service from vendor 32 without identifying himself or herself and without providing payment information to the vendor 32. Purchaser 26 is thus able to maintain his or her anonymity (except with respect to transaction manager 22). Furthermore, purchaser 26 does not face a risk that his or payment information will be compromised and misused.

Transaction completion system 20 also has the advantage that it may be operated at a relatively low cost. Since the actual payment mechanism used to bill purchaser 26 for a transaction existed prior to the use of system 20, it may be used at a nominal marginal cost to charge purchaser 26 for transactions conducted according to the present invention. For example, if the payment mechanism is a periodic invoice which was previously issued to purchaser 26 for a service previously provided by transaction manager 22 (i.e a monthly bill for Internet service provided by transaction manager 22), the invoice will include a charge for the previously provided service as well as a charge corresponding to the transaction. The only additional cost to transmitting the invoice will be the addition of the charge corresponding to the transaction and the subsequent separation of a payment received from the purchaser 26 into a part corresponding to the previously provided service and a part corresponding to the transaction.

Even where a purchaser 26 has specified a credit card number as his or her payment information 64 in step 204, the present method may permit microtransactions to be performed cost-effectively. Credit management server 38 may obtain “pre-authorization” for a relatively large amount of money (compared to the cost of a micro-transaction) from the relevant credit card company. Credit management server 38 may then approve transactions (in step 412) up to the pre-authorized amount before obtaining additional authorization, and then charge the cost of all of these transactions in a single charge to the credit card account. (Alternatively, such a single charge on the credit card account may be made periodically, even if the preauthorized amount has not been reached). This allows the cost of a single credit card transaction to be divided over many micro-transactions.

The cost of operating transaction completion system 20 may be further reduced by eliminating the transmission of itemized list 74 in step 430. The primary use of itemized list by vendor 32 will be to reconcile its records with the payment remitted by transaction manager 22. In a case where each transaction has a relatively small value, this may be an expensive and cost-ineffective process. Accordingly, it may be preferable for vendor 32 to eliminate this reconciliation if the amount of money received from transaction manager 22 is equal to the amount of money expected by vendor 32. This option may be combined with the use of a debit payment system (which is described below) to provide a reliable and cost-effective transaction completion system.

Due to its cost effectiveness (particularly when the use of itemized list 74 to reconcile transactions is eliminated), the present system allows micro-transactions to be completed in a cost effective manner. For example, a newspaper company (i.e. a vendor 32) may allow its archives to be searched and viewed over the Internet at a cost of $0.10 cents per story. The newspaper company's web site may be modified to obtain authorization for each transaction (i.e. the sale of each story) prior to allowing a purchaser 26 to view the story. Periodically, each purchaser who has reviewed one or more stories on the web site will be billed for his use of the newspaper company's web site and periodically the newspaper company will receive payment for the use of its web site by a number of users. The newspaper company does not require its own transaction authorization or billing mechanism, thereby reducing the cost of each transaction to the newspaper company. Periodically, the newspaper company will receive payment for all of the stories sold during the period.

The present invention has been described as an Internet based system with a credit payment basis (i.e. purchasers are permitted to enter a transaction before they are required to provide funds for the transaction).

In a different embodiment of a transaction completion system according to the present invention, communication network 31 may be any type of communication network which allows a session monitor 40 to track data communication during a communication session.

For example, communication network 31 may be the telephone network. In this case, the process of picking up a telephone receiver is sufficient to initiate a communication session 29. The telephone number assigned to the receiver may serve as the purchaser's account code. To ensure that a telephone number assigned to a purchaser is not dishonestly used by another person, step 204 may be modified to allow the purchaser to create a password. Subsequently, in step 402, this password must be entered by the purchaser to activate the transaction completion. For example, the purchaser may enter a “star code”, such as “*90” and then his or her password. A session monitor 40 operated by the telephone company will be initiated in step 404 only if the correct password has been entered. The session monitor 40 may monitor the telephone call to ascertain the information required in steps 408 and 410. A data identification standard suitable for the audio-only communication session of such a network will be specified. For example, the data identification standard may specify audible data identification tags which are used to mark information. These audible tags may or may not correspond to touch tone frequency combinations. Alternatively, the data identification standard may specify these inaudible analog or digital signals tags which are then used to mark (and transmit) information as part of communication session 29 or as part of a separate communication session 68. Session monitor 40 may be configured to receive these tags and the associated information to assemble the information required to authorize a transaction. In another embodiment which may be suitable for use over a telephone network, session monitor 40 may be configured to recognize words spoken by purchaser 26 and/or an automated voice response system operated by vendor 32.

In another embodiment of a transaction completion system according to the present invention, the system may operate on a debit basis. Purchaser 26 may be required to deposit monies with transaction manager 22. Credit management server 38 will be configured to authorize transactions by purchaser 26 only up to the value currently on deposit with transaction manager 22. This system has the advantage that there is no delay in receiving payment from purchaser 26 after a transaction has been authorized and consequently, there is no delay in transaction manager 22 receiving its fee (in step 430) and in vendor 32 receiving payment.

In another embodiment of a transaction completion system according to the present invention, vendor 32 may collect physical address information from purchaser 26 during step 406. This would allow vendor 32 to ship a product directly to purchaser 26 (possibly after receiving confirmation from transaction manager 22 that the product has previously been paid for. This may also allow vendor 32 to present personalized information for purchaser 26 on vendor web site 42. Such an embodiment will not preserve the anonymity of the purchaser 26 with respect to the vendor 32, but this may not be required or desirable in some cases.

In another embodiment of the present invention, communication session 29 and/or communication session 68 may be secured using an encryption mechanism or other security system. This may provide greater security for transaction details and other information transmitted on communication session 29 and 68.

Other variations of the present invention are possible and all these variations fall within the scope of the present invention, which is limited only by the following claims.

1. A method for authorizing an on-line transaction comprising the steps of:
(a) registering a purchaser in a purchaser registry;
(b) registering a vendor in a vendor registry;
(c) initiating a session monitor to monitor data transmitted on a communication session established between a purchaser appliance operated by said purchase and a vendor server operated by said vendor;
(d) recording data related to said transaction;
(e) approving said transaction based on said recorded data, said purchaser registry and said vendor registry.

2. The method of claim 1 wherein said data related to said transaction includes a transaction identification code and the amount of said transaction, and wherein said transaction identification code is identified by a first tag in said communication session and said amount of said transaction is identified by a second tag in said communication session.

3. The method of claim 1 further including the steps of:
(f) transmitting a message indicating the approval of said transaction to said vendor server.

4. The method of claim 2 further comprising the steps of:
(g) collecting money corresponding to said amount of said transaction from said purchaser;
(h) deducting a fee from said money; and
(i) remitting the remainder of said money to said vendor.

5. The method of claim 4 wherein step (g) is performed by deducting said money from an account in to which said purchaser has previously deposited sufficient funds.

6. The method of claim 4 wherein said transaction manager transmits an invoice having a charge corresponding to said amount of said transaction prior to step (g).

7. The method of claim 6 wherein said invoice includes additional charges for products or services which are not related to said transaction.

8. A transaction completion system for authorizing an on-line transaction comprising:
(a) a communication network;
(b) a purchaser appliance;
(c) a vendor server;
(d) a communication gateway coupled to said communication network for controllably allowing a communication session to be created between said purchaser appliance and said vendor server;
(e) a transaction management server for controlling said communication gateway and for initiating a session monitor for tracking data transmitted in said communication session relating to said on-line transaction; and
(f) a credit management server coupled to said transaction management server for authorizing said on-line transaction.
